(19) United States
(12) Patent Application Publication
(10) Pub. No.: US 2026/0233168 A1
(43) Pub. Date: Aug. 13, 2026

(54) CARBON MOLECULAR SIEVE MEMBRANES, METHODS OF MANUFACTURING, AND USE THEREOF

(71) Applicant: Dow Global Technologies LLC, Midland, TX (US)

(72) Inventors: Junqiang Liu, Manvel, TX (US); Dean M. Millar, Midland, MI (US); Kurt A. Koppi, Midland, MI (US)

(73) Assignee: Dow Global Technologies LLC, Midland, TX (US)

(21) Appl. No.: 19/156,222

(22) PCT Filed: Feb. 13, 2024
(86) PCT No.: PCT/US2024/015478

§ 371 Date: Aug. 13, 2025

Related U.S. Application Data
(60) Provisional application No. 63/485,320, filed on Feb. 16, 2023.

(51) Int. Cl. B01D 67/00; B01D 53/22; B01D 69/02; B01D 69/08; B01D 71/02

(52) U.S. Cl. CPC B01D 67/0067; B01D 53/228; B01D 67/0093; B01D 69/02; B01D 69/08; B01D 71/021; B01D 2053/224; B01D 2256/16; B01D 2257/504; B01D 2323/081; B01D 2325/02831; B01D 2325/20

(57) ABSTRACT

A method of manufacturing a carbon molecular sieve (CMS) membrane may comprise forming a copolymer into one or more hollow fibers or one or more microcapillary films, the copolymer selected from one or more of a polyvinylidene chloride (PVDC) copolymer, a polyimide copolymer, polyetherimide copolymer, a polyacrylonitrile copolymer, and a poly(phenylene oxide) copolymer; pyrolyzing the one or more hollow fibers or the one or more microcapillary films at a second temperature of from 600° C. to 700° C. with inert gas or under vacuum; and annealing the one or more hollow fibers or the one or more microcapillary films at a third temperature of from 900° C. to 1500° C. with inert gas or under vacuum; oxidizing the one or more hollow fibers or the one or more microcapillary films at a fourth temperature of from 300° C. to 400° C. with air.

### CROSS-REFERENCE TO RELATED APPLICATIONS

This application claims the benefit of and priority to U.S. Application Ser. No. 63/485,320 filed Feb. 16, 2023, the entire contents of which are incorporated by reference in the present disclosure.

### FIELD

The present disclosure relates to the field of gas separation using a carbon membrane. More particularly, it relates to methods of producing carbon membranes for the separation of gases, as well as methods for the separation of gases from a gaseous mixture by passing the gaseous mixture, such as carbon dioxide-hydrogen gas mixtures, through carbon membranes, as detailed herein.

### BACKGROUND

In the chemical industry, decarbonization technologies are continually being developed due to carbon dioxide (CO₂) emissions being a source of global climate change. One potential decarbonization strategy is the development of hydrogen fuel gas from fuel gases such as methane. However, in this process carbon dioxide is still a by-product, resulting in the need for carbon capture and sequestration strategies from mixed hydrogen-carbon dioxide streams. One common separation method is to capture the carbon dioxide in an amine sweetening process, in which an aqueous solution of amine is flowed over the gas stream, absorbing carbon dioxide and resulting in relatively pure hydrogen for use as fuel. However, thermal energy is often required to vaporize the aqueous amine stream and break the carbon dioxide back out, the fuel for which can originate from hydrocarbon sources. Second, amine itself is toxic and corrosive, such that special handling and additional safety procedures are necessary, adding cost.

Accordingly, methods are desired which can separate carbon dioxide from hydrogen without requiring amine or hydrocarbon-sourced thermal energy. Carbon molecular sieves (CMS) and CMS membranes are one such means that have traditionally been used to separate gas mixtures. CMSs may be prepared from a variety of resins that are pyrolyzed at various temperatures and/or under various conditions. The pyrolysis reduces the resins to carbon, but maintains at least some porosity in the pyrolyzed product, often in the form of micropores. The CMSs thus formed may then be employed in conventional gas separations equipment employing adsorption of particular gases, such as packed beds, columns, and the like, where the micropore size determines which gas in a gas mixture is adsorbed and which gas is not adsorbed. Adsorption and desorption techniques may be alternated to carry out the separation, according to, for example, conventional pressure swing or temperature swing adsorption methods. CMS membranes have also been used to separate gases by flowing gas mixtures through the CMS membranes.

The use of CMSs to accomplish separation generally assumes that the micropores are at least as large as, or larger than, the specified molecule that will enter the micropores. However, there is a particular challenge in preparing CMSs having micropores of the correct size(s) for certain gas separations.

### SUMMARY

CMS membranes may also be sub-categorized based on selectivity. Particularly, CMS membranes may be classified as being normally selective or reverse-selective. Normally selective membranes selectively retain larger molecules while allowing the passage of smaller molecules through the membrane. In contrast, reverse-selective membranes selectively retain smaller molecules while allowing the passage of larger molecules. Reverse-selective membranes may accordingly be desired to effect gas separations of these larger molecules from the smaller molecules. For a membrane to be reverse-selective, ordinarily it has an average pore size greater than the size of the larger molecules. The larger molecules adsorb in the micropores more strongly and prevent the adsorption/permeation of the smaller molecules. The selectivity depends on the micropore size and adsorbate-adsorbent surface interaction.

However, complicating matters, hydrogen molecules are of such a small size that molecules can often pass through even if the membrane is designed be reverse-selective. Accordingly, methods of producing reverse-selective CMS membranes are desired that provide high reverse-selectivity to effect gas separation, particularly separations involving carbon dioxide and hydrogen.

Accordingly, methods of manufacture are discussed herein that produce CMS membranes with the aforementioned benefits. Particularly, formed CMS membranes according to one or more embodiments herein are rendered reverse selective by pyrolysis and oxidation of a copolymer at specific temperature and time thresholds. Further, CMS membranes according to one or more embodiments herein are rendered reverse selective towards carbon dioxide-hydrogen separations in particular by an additional annealing step between the pyrolysis and oxidation steps. Moreover, optional pretreatment of the copolymer, such as a polyvinylidene chloride copolymer, may raise the melting temperature of the same, at least partially stabilizing the copolymer during the later pyrolysis and preventing its collapse or melting. The pyrolysis further increases the carbonization degree of the copolymer, preventing the destruction of the same during later oxidation when carbon atoms are expelled as CO₂/CO from the CMS membrane and oxygenates are formed on the surface of the CMS membrane. The annealing step will reorder and stabilize the carbon structure of the CMS membrane via graphitization, shrinking the pores on average and resulting in more consistent pore sizing that can then be enlarged by the oxidation step. Thus, stable carbon structure with consistent pore sizing may be achieved to allow carbon dioxide-hydrogen separations without substantial hydrogen permeance.

According to one embodiment, a method of manufacturing a carbon molecular sieve (CMS) membrane may comprise forming a copolymer into one or more hollow fibers or one or more microcapillary films, the copolymer selected from one or more of a polyvinylidene chloride (PVDC) copolymer, a polyimide copolymer, polyetherimide copolymer, a polyacrylonitrile copolymer, and a poly(phenylene oxide) copolymer; pyrolyzing the one or more hollow fibers or the one or more microcapillary films at a second temperature of from 600° C. to 700° C. with inert gas or under vacuum; and annealing the one or more hollow fibers or the one or more microcapillary films at a third temperature of from 900° C. to 1500° C. with inert gas or under vacuum; oxidizing the one or more hollow fibers or the one or more microcapillary films at a fourth temperature of from 300° C. to 400° C. with air.

According to another embodiment, a process for separating a gas mixture comprising hydrogen and carbon dioxide may comprise manufacturing a CMS membrane and flowing the gas mixture through the CMS membrane to produce a permeate first stream having an increased concentration of carbon dioxide and a retentate second stream having an increased concentration of hydrogen.

According to yet another embodiment, a carbon molecular sieve (CMS) membrane may comprise one or more hollow fibers or one or more microcapillary films, wherein: the one or more hollow fibers or the one or more microcapillary films comprise a copolymer selected from one or more of a polyvinylidene chloride (PVDC) copolymer, a polyimide copolymer, polyetherimide copolymer, a polyacrylonitrile copolymer, and a poly(phenylene oxide) copolymer; the CMS membrane comprises a carbon dioxide permeance of at least 1000 GPU (Gas Permeation Unit) and a carbon dioxide/hydrogen selectivity of from 50 to 200 at 350 kPa gauge and ambient temperature.

Additional features and advantages of the embodiments described herein will be set forth in the detailed description which follows, and in part will be readily apparent to those skilled in the art from that description or recognized by practicing the embodiments described, including the detailed description and the claims which are provided infra.

### BRIEF DESCRIPTION OF THE DRAWINGS

The following detailed description of specific embodiments of the present disclosure can be best understood when read in conjunction with the following drawings in which:

FIG. 1 is a graphical illustration of weight loss over time of a PVDC fiber of different diameters at a temperature ramp of approximately 5° C. per minute;

FIG. 2 illustrates a carbon molecular sieve membrane composed of a woven matrix of a plurality of hollow fibers, as in embodiments herein;

FIG. 3 is a scatter plot of permeance vs. selectivity for various hollow fibers and microcapillary films, prepared as in embodiments herein;

FIG. 4A is a graphical illustration of carbon dioxide-hydrogen separation performance, particularly permeance to carbon dioxide for four films prepared according to Example 8's procedure, as in embodiments herein;

FIG. 4B is a graphical illustration of carbon dioxide-hydrogen separation performance, particularly permeance to hydrogen, as in embodiments herein;

FIG. 4C is a graphical illustration of carbon dioxide-hydrogen separation performance, particularly selectivity of carbon dioxide over hydrogen, as in embodiments herein;

FIG. 5 is a graphical illustration of micropore size distribution of the films of Film 17 (1200° C. anneal with no oxidation) vs. Film 8 (1200° C. with oxidation in air), as in embodiments herein;

FIG. 6A is a graphical illustration of three carbon dioxide absorption isotherms for a microcapillary film prepared at an annealing temperature of 600° C. and with no oxidation, as in embodiments herein;

FIG. 6B is a graphical illustration of three carbon dioxide absorption isotherms for a similar microcapillary film to FIG. 6A but prepared at an annealing temperature of 900° C. and with no oxidation, as in embodiments herein;

FIG. 7A is a graphical illustration of a oxidation test of time vs. temperature for three microcapillary films annealed at 900° C., 1200° C., and 1500° C., as in embodiments herein; and

FIG. 7B is a graphical illustration of the oxidation test of FIG. 7A of time vs. weight loss of the microcapillary film, as in embodiments herein.

### DETAILED DESCRIPTION

Embodiments described herein relate to methods of manufacturing a carbon molecular sieve (CMS) membrane, as well as processes for utilizing the CMS membrane.

As used herein, “dehydrochlorination” may refer to an elimination reaction which removes a hydrogen, chloride, or hydrogen halide from a substrate. For example, dehydrochlorination of polyvinylidene chloride may involve a 1,2 elimination involving an ion pair or a highly polarized four-center transition state. In another example dehydrochlorination involves the rearrangement at the chloroallyic structure into a cis-allyic configuration that subsequently loses HCl though a six-center concerted process.

The gas permeation properties of a membrane, such as the CMS membranes described in further detail herein, may be determined by gas permeation experiments. Two intrinsic properties have utility in evaluating separation performance of a membrane material: its “permeability,” a measure of the membrane's intrinsic productivity; and its “selectivity,” a measure of the membrane's separation efficiency. One typically determines “permeability” (Pᵢ) in Barrer

$$( 1 Barrer = {10}^{- 10} \frac{{cm}^{3} cm}{{cm}^{2} s cmHg} )$$

calculated as the flux (nᵢ) divided by the partial pressure difference between the membrane upstream and downstream (Δpᵢ), and multiplied by the thickness of the membrane (1). In the embodiments herein, the thickness of the membrane may be generally expressed as the wall thickness, (OD-ID)*/2, of the hollow fibers (1):

$${P}_{i} = \frac{{n}_{i} * l}{Δ {p}_{i}} .$$

Another term, “permeance,” is defined herein as productivity of the CMS membrane or individual hollow fiber and is typically measured in Gas Permeation Units (GPU)

$$( 1 GPU = {10}^{- 6} \frac{{cm}^{3}}{c {m}^{2} s cmHg} )$$

determined by dividing permeability by effective membrane separation layer thickness:

$$( \frac{{P}_{i}}{l} ) = \frac{{n}_{\dot{t}}}{Δ {p}_{i}} .$$

Finally, “selectivity” is defined herein as the ratio of one gas's permeability through the membrane or permeance relative to the same property of another gas. It is measured as a unitless ratio:

$${∝}_{i / j} = \frac{{P}_{i}}{{P}_{j}} = \frac{{P}_{i} / l}{{P}_{j} / l}$$

As previously stated, embodiments herein are directed to methods of manufacturing a carbon molecular sieve (CMS) membrane, as well as processes utilizing the CMS membranes. The method may initially comprise forming a copolymer into one or more hollow fibers or one or more micro capillary films. The method may also optionally comprise pretreating the one or more hollow fibers or the one or more micro capillary films by heating at a first temperature of from 120° C. to 200° C. with air, an inert gas, under vacuum, or combinations thereof. The method may also comprise pyrolyzing the one or more hollow fibers or the one or more microcapillary films at a second temperature of from 600° C. to 700° C. with inert gas or under vacuum. The method may further comprise annealing the one or more hollow fibers or the one or more microcapillary films at a third temperature of from 900° C. to 1500° C. with inert gas or under vacuum. The method may furthermore comprise oxidizing the one or more hollow fibers or the one or more microcapillary films at a fourth temperature of from 300° C. to 400° C. with air.

As previously stated, methods may initially comprise forming the copolymer into hollow fibers or a micro capillary film. The copolymer may be selected from one or more of a polyvinylidene chloride (PVDC) copolymer, a polyimide copolymer, polyetherimide copolymer, a polyacrylonitrile copolymer, and a poly(phenylene oxide) copolymer. In some embodiments the copolymer may be the PVDC copolymer. In other embodiments the copolymer may be the polyimide copolymer.

In embodiments, the copolymer may be formed through copolymerization of the copolymer with a comonomer. The copolymerization method may include but is not be limited to, mass polymerization, suspension polymerization, or emulsion polymerization. It is generally preferred that copolymerization is carried out at a temperature that ensures avoidance of thermal degradation of all of the components, such as from 10 to 120° C., from 20 to 100° C., or from 30 to 90° C., such as in the case of a PVDC copolymer.

As previously stated, the copolymer may comprise at least one of the following comonomers: a vinyl monomer, a vinyl chloride monomer, an acrylate monomer, a methacrylate monomer, a styrenic monomer, acrylonitrile, methacrylonitrile, itaconic acid, and pyrolyzed chlorotrifluoroethylene. In embodiments comprising the PVDC copolymer, the PVDC copolymer may comprise at least 60 wt. %, or alternatively at least 70 wt. %, vinylidene chloride, based on the total weight of the copolymer. The polyvinylidene chloride copolymer may comprise up to approximately 97 wt. % vinylidene chloride, and therefore the polyvinylidene chloride copolymer may comprise at least 3 wt. % of the comonomers previously stated in this paragraph. The polyvinylidene chloride copolymer may comprise from 3 to 40 wt. %, from 3 to 30 wt. %, or from 3 to 20 wt. % of the comonomer. The polyvinylidene chloride copolymer may also comprise from 3.5 to 15 wt. %, from 4 to 12 wt. %, from 7 to 28 wt. %, or from 9 to 25 wt. % comonomer.

Following the copolymerization, the copolymer may be formed into the one or more hollow fibers or the one or more microcapillary films by any suitable method known to those known in the art. For example, the copolymer may be melt-extruded or solution spun in order to form the copolymer into a hollow fiber. Fibers may be produced by uniaxial stretching using known fiber processes for copolymers, and may be round or shaped hollow fibers, or of any other desired hollow fiber morphology. Microcapillary films may be produced by biaxial stretching using known film processes for copolymers. It is also contemplated that precursor films and/or fibers may be coextruded with multiple copolymers and/or with other polymers.

It is noted that the fiber preparation process may optionally comprise stretching, such as stretching of the resin to form a melt-extruded fiber or film. This stretching may, in particular embodiments, be particularly effective in inducing more rapid crystallization and in increasing, and therefore improving, alignment of the crystallites of the one or more hollow fibers. Desirably, the stretch ratio ranges from 1 to 8, such as from 1 to 6, from 1 to 4, and from 2 to 4.

Generally it is useful for the one or more hollow fibers or micro capillary film to have some amount of crystallinity. In the embodiments herein, this crystallinity typically ranges from 25% to 75% of the resin or formed film, as measured by differential scanning calorimetry (DSC) according to ASTM D3418. In embodiments, this level may also range from 30% to 55%, or from 35% to 50%. Thus, inclusion of a comonomer generally helps to reduce precursor crystallinity to ensure the desired range, and also to reduce the melt temperature and thereby improve processability of the resulting copolymer. In general, inclusion of bulkier monomers may tend to reduce overall copolymer crystallinity by a greater amount than inclusion of less bulky monomers. Thus, for example, butyl acrylate may tend to reduce crystallinity more than, for example, methyl acrylate or ethyl acrylate, assuming such is/are used in the same mole percent (mol %) based on final copolymer composition.

In embodiments, the total amount of all additives combined may be no more than 15 wt. %, such as no more than 8 wt. % or no more than 3 wt. % of the one or more hollow fibers or the one or more micro capillary films. In many applications, however, an amount of all additives combined of at least 2 wt. % may be typical, with use thereof therefore ranging from 2 wt. % to 8 wt. %, or from 2 wt. % to 3 wt. % of the one or more hollow fibers or one or more micro capillary films. Those skilled in the art will be aware of the use of such additives and their indications and contraindications without further direction herein.

The one or more hollow fibers may each comprise an inner diameter and an outer diameter. The one or more hollow fibers may also comprise a length. In other words, the one or more hollow fibers may be regarded as tubes. The outer diameter of the one or more hollow fibers may be from 50 microns (micrometers) to 5000 microns. The outer diameter may also be from any narrower range within the 50 to 5000 micron range. For example the one or more hollow fibers may have an outer diameter of from 50 to 100 microns, from 100 to 1000 microns, from 1000 to 2500 microns, from 2500 to 4000 microns, from 4000 to 5000 microns, or any combination of any of the end points of these ranges. The one or more hollow fibers may also have a thickness between the inner diameter and the outer diameter. The thickness may be from 10 microns to 100 microns. For example, the one or more hollow fibers may have an outer diameter of 50 microns with a thickness of 10 microns, such that the inner diameter is 30 microns. The one or more hollow fibers may alternatively have an outer diameter of 5000 microns with a thickness of 100 microns, such that the inner diameter is 4800 microns.

As previously stated, in at least some embodiments, the method may further comprise pretreating the one or more hollow fibers or the one or more microcapillary films by heating at a first temperature of from 120° C. to 200° C. with air, inert gas, under vacuum, or combinations thereof. In embodiments, the pretreatment of the one or more hollow fibers or the one or more microcapillary films may be used to stabilize, or “lock,” the copolymer structure prior to pyrolysis/carbonization thereof, such as when the copolymer is the PVDC copolymer. In at least some embodiments, in this step, the one or more hollow fibers or the one or more microcapillary films may be generally heated below the melting temperature of the PVDC copolymer in order to dehydrochlorinate the fiber to the extent of at least 10%, such as from 10% to 15%, from 15% to 20%, or from 20% to 30%, from 30% to 50%, or any combination of ranges or smaller range therein.

As used herein, the term “at least 10% dehydrochlorinated” means that the hollow fiber has been pre-treated, by removing hydrogen chloride, to a point at which the copolymer hollow fiber no longer melts and, in fact, may begin to become infusible. Without being limited by theory, such a change in molecular kinetics may begin to occur at a point of approximately 10% dehydrochlorination and may be completed or maintained as the level of dehydrochlorination increases above that point. In embodiments, this ‘locking’ of the copolymer structure may prevent further deformation or curvature in the pyrolysis and oxidation steps after pretreatment. In other words, due at least partly to the fact that the copolymer no longer melts, the copolymer may be regarded as self-supporting, i.e. the copolymer may bear its own weight during further pyrolysis, where the copolymer structure may be further strengthened.

The first temperature may also be at any temperature range within 120° C. to 200° C. For example, the one or more hollow fibers or the one or more microcapillary films may be heated at the first temperature of from 120° C. to 130° C., from 130° C. to 150° C., from 150° C. to 160° C., from 160° C. to 180° C., from 180 to 190° C., from 190 to 200, or any combination of ranges or smaller range therein. In embodiments, heating at any of these temperatures may also crosslink an interior of the one or more hollow fibers or the one or more microcapillary films.

In embodiments, the one or more hollow fibers or the one or more microcapillary films may be pretreated for a period of from 10 minutes to 72 hours, such as from 10 minutes to 30 minutes, from 30 minutes to 1 hour, from 1 hour to 2 hours, from 2 hours to 10 hours, from 10 hours to 20 hours, from 20 hours to 40 hours, from 40 hours to 60 hours, from 60 hours to 72 hours, or any combination of ranges or smaller range therein.

Pretreating the one or more hollow fibers or the one or more microcapillary films may further comprise contacting the one or more hollow fibers or the one or more microcapillary films with air, inert gas, or both. Contacting the one or more hollow fibers or the one or more microcapillary films with air or inert gas may occur at a rate sufficient to purge the pretreatment gas products, such as methane, hydrogen, carbon monoxide, and carbon dioxide, thereby preventing secondary reactions of the pretreatment gas products on the carbon surface.

As previously stated, the method may further comprise pyrolyzing the one or more hollow fibers or the one or more microcapillary films at the second temperature of from 600° C. to 700° C. with inert gas or under vacuum. In embodiments, the pyrolysis may result in at least 90 wt. % of the copolymer becoming carbonized, such as at least 95 wt. %, or at least 99 wt. %. As already pointed out hereinabove, pyrolysis is also termed “carbonization,” because the result thereof is that the copolymer may be converted to a carbon-only, or near carbon-only, skeleton of its copolymer structure, i.e., all or virtually all atoms other than carbon have been removed, but the carbon-carbon bonds remain substantially intact, and the one or more hollow fibers or the one or more microcapillary films may now be termed to be “carbonaceous.” The pyrolysis may be carried out using any means generally known to those skilled in the art.

The second temperature may also be at any narrower temperature range within the 600 to 700° C. For example, the one or more hollow fibers or the one or more microcapillary films may be pyrolyzed at the second temperature of from 600° C. to 625° C., from 625 to 650° C., from 650° C. to 675° C., from 675° C. to 700° C., or any combination of ranges or smaller range therein, such as from 625° C. to 675° C. As previously stated, pyrolyzing the one or more hollow fibers or the one or more microcapillary films at the second temperature may further comprise contacting the one or more hollow fibers or the one or more microcapillary films with inert gas.

In embodiments, inert gas may comprise carbon dioxide; nitrogen; any noble gas (including but not limited to argon); or combinations thereof. Contacting the one or more hollow fibers or the one or more microcapillary films with inert gas may occur at a rate sufficient to purge away the pyrolysis gas products, thereby preventing secondary reactions of the pyrolysis gas products on the carbon surface.

In embodiments, the one or more hollow fibers or the one or more microcapillary films may be pyrolyzed at the second temperature for a period of from 10 minutes to 72 hours, such as from 10 minutes to 30 minutes, from 30 minutes to 1 hour, from 1 hour to 2 hours, from 2 hours to 10 hours, from 10 hours to 20 hours, from 20 hours to 40 hours, from 40 hours to 60 hours, from 60 hours to 72 hours, or any combination of ranges or smaller range therein.

As previously stated, the method may further comprise annealing the one or more hollow fibers or the one or more microcapillary films at the third temperature of from 900° C. to 1500° C. with inert gas or under vacuum. The third temperature may also be from 900° C. to 1000° C., from 1000° C. to 1100° C., from 1100° C. to 1200° C., from 1200° C. to 1300° C., from 1300° C. to 1400° C., from 1400° C. to 1500, or combinations of the previous ranges or smaller ranges therein, such as from 1200° C. to 1500° C.

In embodiments, the one or more hollow fibers or the one or more microcapillary films may be annealed at the third temperature for a period of from 10 minutes to 72 hours, such as from 10 minutes to 30 minutes, from 30 minutes to 1 hour, from 1 hour to 2 hours, from 2 hours to 10 hours, from 10 hours to 20 hours, from 20 hours to 40 hours, from 40 hours to 60 hours, from 60 hours to 72 hours, or any combination of ranges or smaller range therein.

In at least some embodiments, the method may further comprise cooling the one or more hollow fibers or the one or more microcapillary films to a temperature of less than or equal to 60° C. between pyrolyzing and annealing. Without being limited by theory, in the case of a batch pyrolysis furnace, this cooling step may allow the removal of pyrolysis gas products prior to the annealing step. However, in embodiments not comprising a batch pyrolysis furnace, such as a continuous process, the method may progress from the pyrolysis step to the annealing step without cooling the one or more hollow fibers or the one or more microcapillary films.

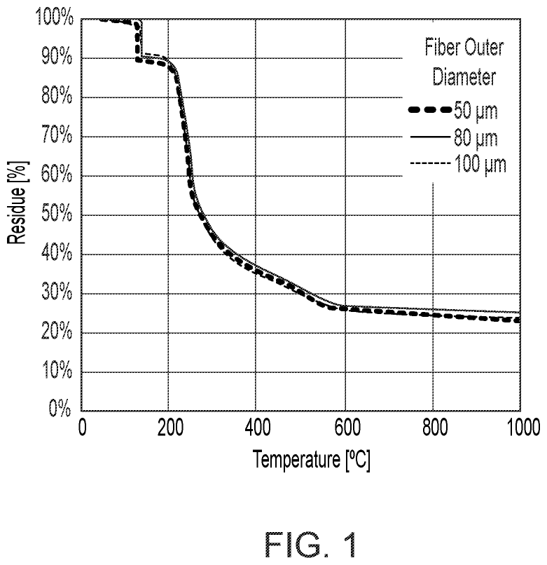

In at least some embodiments, the cooling step, the annealing step, or both may occur after observing greater than or equal to 70 percent weight loss of the one or more hollow fibers or the one or more microcapillary films in the pyrolyzing step. Without being limited by theory, and as illustrated in FIG. 1, upon reaching 70 percent weight loss or greater in pyrolysis, the weight loss of the one or more hollow fibers or the one or more microcapillary films begins to stabilize, indicating that the reaction has started to progress from pyrolysis to annealing, with the reordering and stabilizing of the carbon structure generally observable in the same. While FIG. 1 illustrates the weight loss for hollow fibers, the same trend should also hold for microcapillary films. Moreover, as shown in FIG. 1, this trend is consistent regardless of the thickness of the hollow fiber, which is also expected to be true for the microcapillary film.

As previously stated, the method may further comprise oxidizing the one or more hollow fibers or the one or more microcapillary films at the fourth temperature of from 300° C. to 400° C. with air. The fourth temperature may also be from 300° C. to 310° C., from 310° C. to 350° C., from 350° C. to 375° C., from 375° C. to 400° C., or any combination of ranges or smaller range therein.

In embodiments, air may comprise from 10 wt. % to 30 wt. % oxygen, such as approximately 20 wt. % oxygen, or such as from 10 wt. % to 12 wt. %, from 12 wt. % to 18 wt. %, from 18 wt. % to 22 wt. %, from 22 wt. % to 28 wt. %, from 28 wt. % to 30 wt. %, or any combination of ranges or smaller range therein, such as approximately 20 wt. % oxygen by weight of air. Without being limited by theory, the oxygen content of air may impact the rate of oxidation of the one or more hollow fibers or the one or more microcapillary films. For instance, at greater oxygen contents, the oxidation rate of the one or more hollow fibers or the one or more microcapillary films may correspondingly increase. It is also known that steam and CO₂ may be milder oxidants than air. Accordingly, without being limited by theory, a similar level of oxidation and pore opening may be achievable with steam and/or CO₂ at higher temperatures than for air.

In embodiments, the one or more hollow fibers or the one or more microcapillary films may be oxidized at the fourth temperature for a period of from 10 minutes to 40 hours, such as from 10 minutes to 30 minutes, from 30 minutes to 1 hour, from 1 hour to 2 hours, from 2 hours to 10 hours, from 10 hours to 20 hours, from 20 hours to 30 hours, from 30 hours to 40 hours, from 40 hours to 42 hours, or any combination of ranges or smaller range therein. However, the oxidation may also occur over a much larger timeframe/range, such as from 10 minutes to 7 days.

Without being limited by theory, it is contemplated that the oxidation of the one or more hollow fibers or the one or more microcapillary films may operate to increase the pore volume of the same. Particularly, oxidation may operate to expel carbon atoms (such as in the form of CO and/or CO₂ gas) from the one or more hollow fibers or the one or more micro capillary films along the edges of the previously created pore walls, thus enlarging them. The enlarging of the pores may lead to a general increase in permeance among all gas species with representative molecular diameters less than the pore size. However, the oxidation may also lead to a relatively greater increase in permeance for more strongly adsorbed gases (e.g. CO₂) vs. less strongly adsorbed gases (e.g. H₂), due primarily to gas absorption effects within the pores of the one or more hollow fibers or the one or more microcapillary films. In embodiments, the oxidation step may be stopped at less than 20 wt. % loss of the one or more hollow fibers or the one or more microcapillary films in the oxidation step.

As explained in further detail hereinbelow, annealing the one or more hollow fibers or the one or more microcapillary films at a temperature of greater than or equal 900° C. may operate to reorder and stabilize the carbon structure of the CMS membrane, shrinking the pores on average and resulting in more consistent pore sizing that can then be enlarged by the oxidation step. The annealing may also have the secondary benefit of making the CMS membrane more resistant to general carbon expulsion during oxidation. Without being limited by theory, this increase in resistance of the one or more hollow fibers or the one or more microcapillary films may operate to concentrate carbon expulsion around the pores, rather than on the supporting structure of the one or more hollow fibers or the one or more microcapillary films. The result may be an enlarging of the pore throats during subsequent oxidation without shattering of the one or more hollow fibers or the one or more microcapillary films.

As previously discussed, the CMS membranes formed according to methods herein may be self-supported. In other words, and in one or more embodiments, the CMS membrane does not comprise a supporting structure to the CMS membrane. The CMS membranes formed according to methods herein may have an oxygen content of from 5 atom % (atomic ratio) to 17 atom %, such as from 5 atom % to 7 atom %, from 7 atom % to 9 atom %, from 9 atom % to 12 atom %, from 12 atom % to 16 atom %, from 16 atom % to 17 atom %, or any combination of ranges or smaller range therein. The CMS membranes formed according to methods herein may also have a carbon content of from 82 atom % to 94 atom %, such as from 82 atom % to 83 atom %, from 83 atom % to 86 atom %, from 86 atom % to 90 atom %, from 90 atom % to 92 atom %, from 92 atom % to 94 atom %, or any combination of ranges or smaller range therein.

With respect to the previous oxygen and carbon content ranges, it is contemplated that a certain degree of oxidation may be needed to reach a particular level of pore opening. Particularly, during oxidation, two reactions may be occurring: oxygenate formation on carbon surface and CO/CO₂ gas formation. Accordingly, the oxygen content of the CMS membranes may correlate with the extent of pore opening and/or the degree of oxidation. In embodiments, the CMS membrane may comprise an oxygen content of from 5 atom % to 15 atom %.

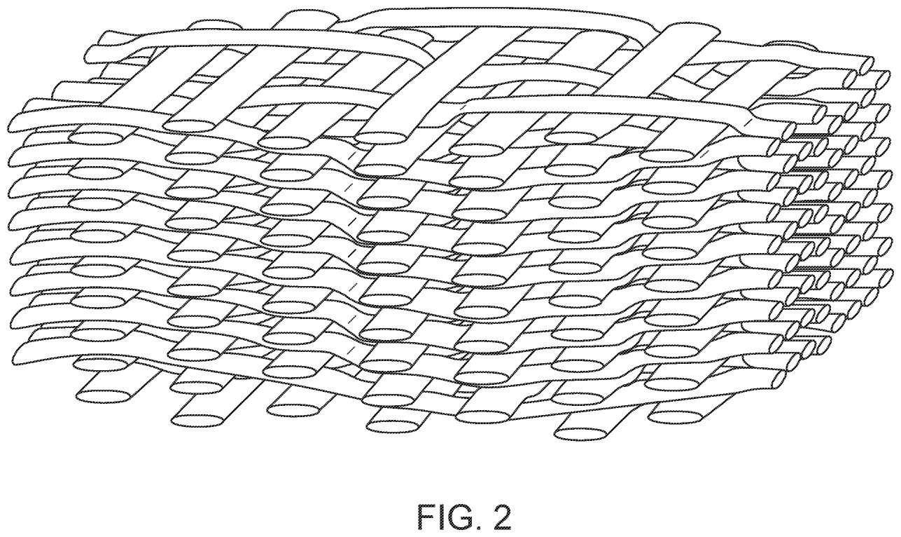

As previously discussed, embodiments herein may also be directed to CMS membranes. The CMS membranes may be any of the CMS membranes formed according to the methods previously discussed. In embodiments, and as illustrated in FIG. 2, the one or more fibers of the CMS membranes may be a first plurality of hollow fibers and a second plurality of hollow fibers. The first plurality of hollow fibers and the second plurality of hollow fibers may also be arranged in a woven lattice structure, as shown in FIG. 2. The first plurality of hollow fibers and the second plurality of hollow fibers may also be arranged in the woven lattice structure for the pretreating step, the pyrolyzing step, the cooling step, the annealing step, the oxidizing step, or combinations thereof. It is contemplated that this woven breathable structure will help to reach more uniform temperature and gas composition at the solid/gas interface. This is especially critical for the oxidation step to achieve the same degree of oxidation. The woven lattice structure may be preferably formed at the polymeric state before the thermal conversion. Without being limited by theory, it is contemplated that the flexible polymer structure is easier to weave into structure.

In other embodiments, the one or more hollow fibers or the one or more microcapillary films may be bundled together to form the CMS membrane, such as by using an adhesive or a binding mechanism.

As previously discussed, the CMS membranes may have a permeance, expressed as the permeability to flow a gas over the membrane layer thickness (individual hollow fiber wall thickness). However, the CMS membranes may have different permeances for different sized gases. As previously discussed, the ratio of these different permeances may be expressed as a selectivity for a given gas. For instance, the CMS membrane may selectively separate different gases from each other. As discussed in further detail below, this may allow the CMS membranes to act as a preferential separator of different sized gases. The CMS membranes herein may also be reverse-selective. In other words, they may preferentially reject a smaller gas molecule from the membrane while accepting (and passing through) a larger gas molecule.

In embodiments, in an at least a carbon dioxide and hydrogen environment, the CMS membranes herein may have a carbon dioxide permeance of at least 1000 GPU or of at least 2000 GPU, such as from 1000 GPU to 1500 GPU, from 1500 GPU to 2000 GPU, from 2000 GPU to 2500 GPU, from 2500 GPU to 3000 GPU, or any combination of the previous ranges or smaller range therein, such as from 1000 GPU to 3000 GPU. The CMS membranes herein may also have a hydrogen permeance of less than 40 GPU, such as from 40 GPU to 30 GPU, from 30 GPU to 20 GPU, from 20 GPU to 10 GPU, from 10 GPU to 1 GPU, or any combination of the previous ranges or smaller range therein, such as from 1 GPU to 40 GPU.

The CMS membranes herein may also have a carbon dioxide/hydrogen mixed gas selectivity of greater than 50, such as from 50 to 70, from 70 to 80, from 80 to 100, from 100 to 120, from 120 to 140, from 140 to 160, from 160 to 180, from 180 to 200, or any combination of the previous ranges or smaller range therein, such as from 80 to 200 or 50 to 200 at ambient temperature. Without being limited by theory, the above selectivities may allow the CMS membrane to preferentially separate the heavier carbon dioxide gas molecules from the lighter hydrogen molecules.

Without being limited by theory, permeance and selectivity may be dependent on temperature and pressure. Accordingly, the aforementioned permeances and selectivities may be understood to occur at ambient temperature (20° C.) and 350 kPa gauge pressure, and thus may also be understood to change with respect to different temperatures and/or pressure. Particularly, it is contemplated that CO₂ permeance may be understood to increase if measured at temperatures above ambient, and decrease at temperatures below ambient. The CO₂/H₂ selectivity may be understood to increase at lower temperature, and decrease at higher temperature.

As stated above, embodiments herein are also directed to processes for separating gases from a gas mixture. The gas mixture may comprise first gas molecules and second gas molecules. The second gas molecules (i.e. hydrogen) may have a lesser representative molecular diameter than the first gas molecules (i.e. carbon dioxide). The process may comprise forming a CMS membrane and flowing the gas mixture through the CMS membrane to produce a permeate first stream and a second retentate stream. The CMS membrane used in the process may be any of the CMS membranes previously discussed. The permeate first stream may have an increased concentration of the first gas molecules as compared to the second retentate stream, which in turn may have an increased concentration of the second gas molecules as compared to the permeate first stream. In this way, the CMS membrane used in the process may operate to separate the first gas molecules and the second gas molecules from each other, and may be reverse-selective.

As previously stated, determining the micropore/molecular sizing of the CMS membranes is important to determine the CMS membranes' suitability for particular separations. Different ways to determine the molecular size have been developed. One commonly employed approach has been to determine a given molecule's “kinetic diameter.” A reference listing a variety of these kinetic diameters, based upon their use in zeolite applications, is D. W. Breck, Zeolite Molecular Sieves: Structure, Chemistry and Use, John Wiley & Sons, Inc. (New York, N.Y. 1974), 636, and these determinations are frequently used even with respect to non-zeolite, carbon molecular sieves that are known to have slit-shaped pores. In view of the above and for purposes hereof, then, the following kinetic diameters, taken from the Breck reference cited supra, are used herein as the representative molecular diameters for the following molecules: He (2.6 Angstroms, Å), H₂ (2.89 Å), N₂ (3.64 Å), CO₂ (3.3 Å), CH₄ (3.8 Å), C₂H₄ (3.9 Å), C₃H₈ (4.3 Å), i-C₄H₁₀ (5.0 Å), SF₆ (sulfur hexafluoride) (5.5 Å), and i-C₈H₁₈ (iso-octane) (6.2 Å). However, because that reference table lacks a kinetic diameter for ethane, and the kinetic diameter given therein for propylene is believed by at least some researchers to be inaccurate for CMS materials per se, the Lennard-Jones collision diameters are used herein, instead of the Breck kinetic diameters, for those two materials. These Lennard-Jones collision diameters are, respectively, C₂H₆ (4.1 Å), and C₃H₆ (4.0 Å). See, for example, Staudt-Bickel C., Koros W. J., “Olefin/paraffin gas separations with 61-DA-based polyimide membranes,” J. Membr. Sci. (2000) 170 (2), 205-214 for further discussion. The kinetic diameters and Lennard-Jones collision diameters are referred to together as “representative molecular diameters.”

In embodiments, the CMS membrane may have an average and/or median pore size greater than the first gas molecules' (i.e., carbon dioxide's) representative molecular diameter, such as at least two times greater. The average/median pore size of the CMS membrane may be determined through gas adsorption techniques, employing gas probe molecules of differing sizes. The CMS membrane may have an average/median pore size of from approximately 4.5 angstroms to approximately 7 angstroms, such as from approximately 4.5 angstroms to 5 angstroms, from approximately 5 angstroms to approximately 6 angstroms, from approximately 6 angstroms to approximately 6.6 angstroms, from approximately 6.6 angstroms to approximately 7 angstroms, or any combination of the previous ranges or smaller range therein, such as from 5 angstroms to 7 angstroms. Without being limited by theory, an average/median pore sizing of from 6.6 angstroms to 7 angstroms may theoretically allow the absorption and surface flow of two layers of carbon dioxide molecules while leaving no space for the permeation of hydrogen molecules, as the representative molecular diameter of carbon dioxide is estimated at 3.3 angstroms. Moreover, an average/median pore sizing of from 4.5 angstroms to 6 angstroms may theoretically allow the absorption and surface flow of carbon dioxide molecules while leaving no space for the permeation of hydrogen molecules, as the representative molecular diameter of carbon dioxide is estimated at 3.3 angstroms and the representative molecular diameter of hydrogen is estimated at 2.9 angstroms (approximately 6.2 angstroms in combination).

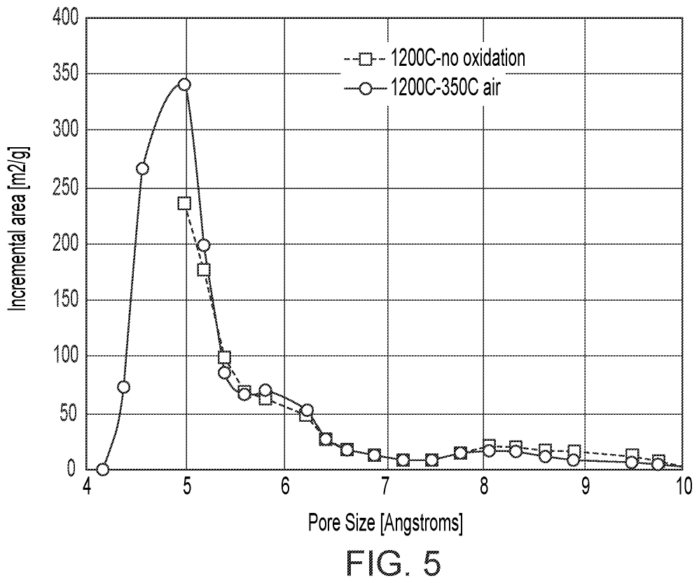

As previously stated, the average/median pore size may be determined by gas adsorption. A slit pore structure is assumed by partially graphitized nanosheets. For example, and as illustrated in FIG. 5, the CMS membrane may have a total pore size distribution wider than between 4 angstroms and 10 angstroms. In embodiments, the CMS membranes formed according to methods herein may have a maximum pore size of approximately 10 angstroms.

In addition to average micropore size, it is also often desirable in the art to optimize total micropore volume, which may be measured via the Brunauer-Emmett-Teller (BET) method at liquid N₂ temperature. Such may be further confirmed via helium (He) pycnometry and mercury (Hg) intrusion. For most separations applications, a total micropore volume of at least 0.10 mL/g, preferably at least 0.15 mL/g, more preferably at least 0.20 mL/g, according to the BET method at liquid N₂ temperature, may be needed to ensure commercially efficient desirable gas adsorption.

### Examples

Hollow fibers and microcapillary films were formed according to embodiments herein for permeation testing, as explained in further detail hereinbelow.

### Hollow Fiber Preparation

Three different categories of hollow fibers were prepared, according to embodiments herein by either melt extruding or solution spinning, as explained in more detail below. Particularly, the first category of hollow fibers (PVDC hollow fibers) were formed by melt extruding a PVDC copolymer of vinyl chloride. The fiber has an outer dimeter (OD) and an inner diameter (ID) of 164 microns and 76 microns, respectively.

The second category of hollow fibers (6FDA hollow fibers) were formed by solution spinning of polyimide 6FDA/BpDA-DAM polymer using the method specified in publication (Xu, et al., Physical aging in carbon molecular sieve membranes. Carbon 2014, 80, 155-166). The fiber had an OD and ID of 580 microns and 440 microns, respectively. The asymmetric hollow fiber wall also had a thickness of less than 5 microns.

The third category of hollow fibers (Matrimid hollow fibers) were formed by solution spinning of Matrimid polyimide polymer using the method specified in publication (Xu et al., Matrimid (R) derived carbon molecular sieve hollow fiber membranes for ethylene/ethane separation. J. Membr. Sci. 2011, 380 (1-2), 138-147). The fiber had an OD and ID of 400 microns and 230 micron, respectively. The asymmetric hollow fiber wall also had a thickness of less than 1 micron.

### Hollow Fiber Testing Procedure

Each of the hollow fibers were threaded individually through alumina tubes. The alumina tube kept individual hollow fibers straight and separated during pyrolysis. For the PVDC hollow fiber, the precursor fiber was pretreated to crosslink at 130° C. in a low temperature oven purged with 2 liters per minute (L/min) of air. Pretreatment was not conducted for the 6FDA/BpDA-DAM hollow fibers or the polyimide hollow fibers. The bundle of alumina tube containing fibers was then pyrolyzed 600° C. and annealed at 900° C. at a 3° C./min ramp then held for 2 hours before cooling down in a 6″ OD quartz tube furnace. A flow of 5 L/min of nitrogen purge was used to keep the furnace free of oxygen.

A bundle of each category of pyrolyzed fiber were then inserted in a 0.25″ ID alumina tube, which was then put in a quartz tube furnace for oxidation. The furnace was continuously purged by air. The furnace was heated to a peak temperature between 275° C. to 400° C. at a ramp of 1° C./min before holding for 8 hours. The furnace was then let to cool down to room temperature before unloading the samples. The obtained CMS membrane fibers were kept in a nitrogen box unless otherwise specified before making into modules for permeation tests.

### Microcapillary Film Preparation

Microcapillary films, according to embodiments herein, were extruded using PVDC resins obtained from SK Global SARAN, particularly SBR711, which is a PVDC copolymer resin containing approximately 8.5 wt. % methyl acrylate. In particular, the microcapillary film die had a simple split body design with a two-inch wide air manifold insert that contained 42 parallel hollow pins positioned near the exit of the die used to introduce air into the polymer melt forming microcapillaries. The extruder pumping rate and air flow rate were adjusted to achieve the desired microcapillary diameter.

A 0.75-inch diameter single screw extruder with three-barrel temperature zones was used to extrude the PVDC microcapillary film samples. An elbow adaptor was fabricated to position the microcapillary film die such that the extruded tape will be directed down into a water bath. The elbow and die were heated using metal heating elements that were clamped in place. The temperatures of the three zones of the extruder, the elbow, and die were increased from 155° C. to 170° C. until no unmelt resin was seen in the extruded film. The temperatures were kept as low as possible to avoid the thermal decomposition of PVDC resin. Polyethylene (PE) resin was periodically fed into the extruder to flush out char build up periodically.

Upon extrusion from the die, the microcapillary film was quenched into a room temperature water bath where upon it was wrapped around a guide roll at the bottom of the bath and then pulled out of the bath by a winder. The film was stretched by increasing the speed of the winder. Stretching occurred near the exit of the die and reduced the film thickness as well as the film width. The extruded microcapillary films were then cut into approximately 3-foot strips and laid out on the top of a flat lab bench in atmospheric conditions to fully crystallize the PVDC for approximately one week.

### Microcapillary Film Testing Procedure

Microcapillary tapes of 7.5 cm length were cut out of the melt extruded films. The tapes were then placed between two honeycomb ceramic plates. Two pieces of Whatman filter paper (Whatman 1003-125) were placed between the PVDC microcapillary film and the porous ceramic plates (each ~100 grams) as a cushion. The tape/filter paper/ceramic plates sandwich was placed in an air purged (5 Liter/min) oven for pretreatment. The temperature of the oven was raised to 130° C. at a ramp of 1° C./min and then kept at 130° C. for 24 hours. The sandwich was taken out after the oven cooled down below 60° C.

The pretreated microcapillary film together with the filter paper and porous ceramic plate were then placed into a quartz tube furnace purged by nitrogen gas. The furnace was first raised to 250° C. at 0.1° C./min, and then to a final pyrolysis temperature ranging from 600 to 900° C. at a 3° C./min ramp and kept at the final temperature for two hours before cooled down. The samples were taken out after the furnace cooled down below 60° C.

Some of the pyrolyzed microcapillary films were then placed into an alumina tube furnace purged by nitrogen gas for the annealing step. The remaining microcapillary films were kept as control comparisons for no annealing. The furnace was first raised to the final temperature of 900-1500° C. at 5° C./min, and then kept at the final temperature for 120 min before cooled down. The samples were taken out after the furnace cooled down below 60° C.

Some of the pyrolyzed or annealed microcapillary films were then placed into a quartz tube furnace purged by air for the oxidation step. The remaining microcapillary films were kept as control comparisons for no oxidation. The furnace was first raised to the final temperature at 3° C./min ramp and kept at the final temperature for 8 hours before being cooled down. The obtained CMS membrane films were kept in a nitrogen box unless otherwise specified before making into modules for permeation tests.

### Permeation and Selectivity Testing

As previously stated, each of the CMS membranes were then stored in nitrogen gas-rich containers until testing. Each of the CMS membranes previously formed and discussed were then tested for gas permeation, as well as gas selectivity. This was accomplished by building custom made ring permeation cell “modules.” The ring cell has a five-inch outer diameter, a three inch inner diameter, four half-inch wide openings on the wall with 9/16 inch o-ring fitting and quarter-inch thick covers at two side with the o-ring seal. The o-rings were provided by SAE/MS.

For the hollow fibers, two of the fibers according to the Examples hereinabove were inserted into the half-inch wide openings on the wall of the ring cell. A dam was made using Teflon tape around the fibers inside the hole. An epoxy resin, (Scotch Weld DP100@) was used to fill the space around the hollow fiber hole and form a seal.

For the micro capillary film, similar custom made ring permeation cell “modules” were used. One end of the micro capillary film was inserted into one of the half-inch wide openings. Similar to the hollow fiber modules, a dam was then made using Gorilla All Purpose Putty Epoxy Stick, with Scotch Weld DP100 epoxy used to fill the top of the Gorilla Putty Epoxy as well as seal the other end of the micro capillary film.

Mixture gas permeation was tested using the modules. Mixed gases were first cleaned through an activated carbon guard bed, then fed into the reservoir inside the ring cell. The feed was a equimolar 52 psi gauge carbon dioxide/hydrogen feed, to reflect the feed from hydrogen fuel gas creation. The permeance was calculated using the permeate flow rate, normalized by the cross-membrane pressure difference and the total membrane surface area. For microcapillary film, the membrane area is the product of un-sealed film length, width, and 2 (each microcapillary film has two surfaces). The unit of permeance is GPU: 1×10−6 cm3(S.T.P)/(s·cm2·cm Hg). The results of the permeation testing are shown below in Tables 1 and 2 below.

TABLE 1
Hollow Fiber Permeation Test Results

| | | Anneal | Oxidation | CO₂ | H₂ | |
|---|---|---|---|---|---|---|
| | | Temp | Temp | Perm | Perm | CO₂/H₂ |
| Example | Copolymer | (° C.) | (° C.) | GPU | GPU | Selectivity |
| Fiber 1 | PVDC | 900 | 350 | 1725 | 110 | 16 |
| Fiber 2a | 6DFA | 900 | 275 | 1023 | 19 | 55 |
| | (polyimide) | | | | | |
| Fiber 2b | 6DFA | 900 | 300 | 3864 | 81 | 48 |
| | (polyimide) | | | | | |
| Fiber 2c | 6DFA | 900 | 350 | Broken | | |
| | (polyimide) | | | | | |
| Fiber 3a | Matrimid | 900 | 350 | 1241 | 14 | 91 |
| | (polyimide) | | | | | |
| Fiber 3b | Matrimid | 900 | 375 | Broken | | |
| | (polyimide) | | | | | |

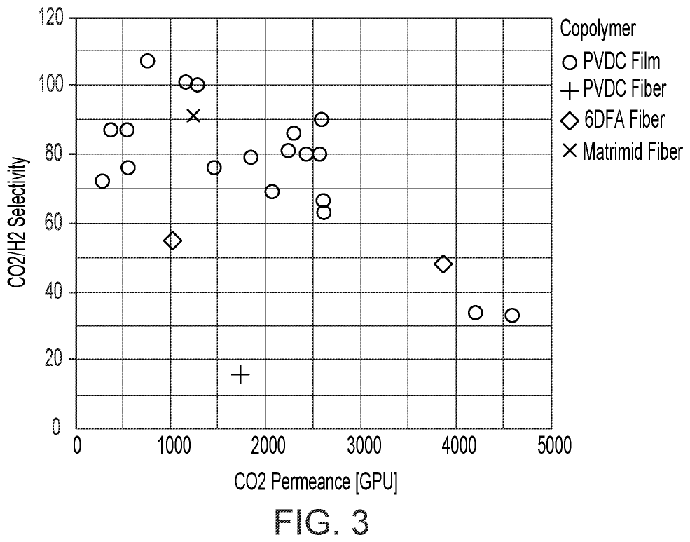

As shown above in Table 1, Fibers 1-3b were pyrolyzed at a temperature of 600° C. and then annealed at a temperature of 900° C. under nitrogen purge. The hollow fibers were then oxidized for 8 hours at a 3° C./min ramp. The oxidation temperatures are as shown above in Table 1. Ten fibers, three fibers, and three fibers were formed per batch for Fibers 1, 2, and 3, respectively. As shown above in Table 1, only Fiber 2a, oxidation at 275° C., exhibited preferred results, with Fiber 2a exhibiting sufficient selectivity and carbon dioxide permeance, but also increased hydrogen permeance. For Fibers 1, 3a, and 3b, the fibers either did not exhibit sufficient selectivity or shattered a majority of the time during formation. FIG. 3 illustrates a scatter plot of carbon dioxide permeance (x-axis) vs. carbon dioxide-hydrogen selectivity for each of the aforementioned fibers, as well as the microcapillary films described hereinbelow. As shown in FIG. 3, the PVDC microcapillary film exhibited the best tradeoff between high carbon dioxide permeance while also achieving sufficient selectivity.

TABLE 2
Microcapillary Film Permeation Test Results

| | | Anneal | Oxidation | CO₂ | H₂ | |
|---|---|---|---|---|---|---|
| | | Temp | Temp | Perm | Perm | CO₂/H₂ |
| Example | Copolymer | (° C.) | (° C.) | GPU | GPU | Selectivity |
| Film 1 | PVDC | 900 | 275 | 550 | 10 | 76 |
| Film 2 | PVDC | 900 | 300 | 1451 | 19 | 76 |
| Film 3a | PVDC | 900 | 325 | 2048 | 30 | 69 |
| Film 3b | PVDC | 900 | 325 | 2236 | 28 | 81 |
| Film 4a | PVDC | 900 | 350 | Broken | | |
| Film 4b | PVDC | 900 | 350 | 4598 | 140 | 33 |
| Film 5 | PVDC | 1200 | 275 | 375 | 6 | 87 |
| Film 6 | PVDC | 1200 | 300 | 546 | 6 | 87 |
| Film 7a | PVDC | 1200 | 325 | 1265 | 13 | 100 |
| Film 7b | PVDC | 1200 | 325 | 1156 | 11 | 101 |
| Film 8a | PVDC | 1200 | 350 | 2430 | 30 | 80 |
| Film 8b | PVDC | 1200 | 350 | 2293 | 27 | 86 |
| Film 8c | PVDC | 1200 | 350 | 2558 | 32 | 80 |
| Film 8d | PVDC | 1200 | 350 | 2589 | 29 | 90 |
| Film 9 | PVDC | 1200 | 375 | 4579 | 137 | 33 |
| Film 10 | PVDC | 1500 | 325 | 286 | 4 | 72 |
| Film 11 | PVDC | 1500 | 350 | 752 | 7 | 107 |
| Film 12 | PVDC | 1500 | 375 | 1842 | 23 | 79 |
| Film 13 | PVDC | 1500 | 400 | 4206 | 124 | 34 |

As shown above in Table 2, the films were pyrolyzed at a temperature of 600° C. and then annealed at temperatures ranging from 900° C. (films 1-4b), 1200° C. (films 5-9), and 1500° C. (films 10-13) under nitrogen purge. The hollow fibers were then oxidized for 8 hours at a 3° C./min ramp. The oxidation temperatures are as shown above in Table 1. Three films were formed per batch of oxidation for Films 1-13.

As shown above in Table 2, for all films, carbon dioxide permeance was observed to increase as oxidation temperature increased. These same trends were not observed in hydrogen permeance, as a large hydrogen permeance jump, (and associated decrease in selectivity) was only observed when oxidation temperature exceeded a given threshold for a given annealing temperature. Particularly, for films annealed at 900° C. (1-4b), there was an observable drop in selectivity when oxidation increased past 325° C., as shown in films 4a and 4b. For films annealed at 1200° C. (5-9), there was an observable drop in selectivity when oxidation increased past 350° C., as shown in film 9. For films annealed at 1500° C. (10-13), there was an observable drop in selectivity when oxidation increased past 375° C., as shown in film 13.

Without being limited by theory, high hydrogen permeance may not be desired due to the intended separations, as hydrogen intended for hydrogen fuel may pass through the membrane, limiting economic viability of the separation process. Low carbon dioxide permeance may not be desired for similar reasons, as large amounts of carbon dioxide-hydrogen mixtures need to be separated to render the process economical over comparative amine sweetening separation. Shattered results may not be desired because they may indicate the process is not readily repeatable, reducing the ability of the CMS membrane to produced in scale.

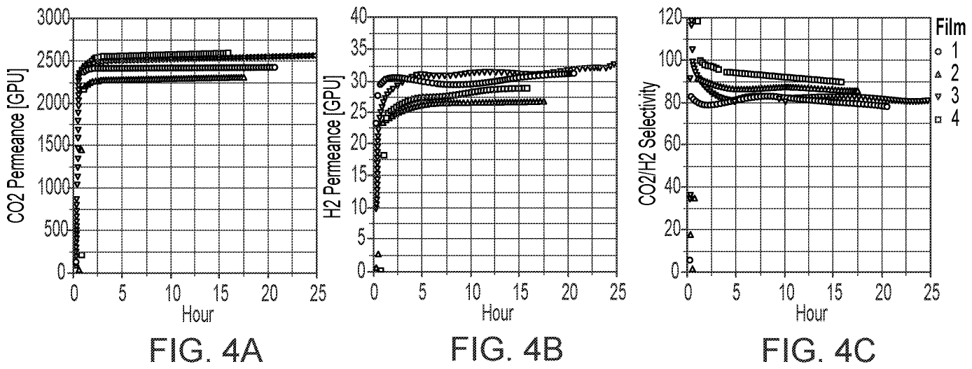

To test the consistency of performance of the membranes, four films of Example 8 were randomly chosen to make four modules for gas permeation testing. As shown in FIGS. 4A-4C, permeation testing of Film 8 indicated that the membrane achieved permeance and selectivity metrics with a standard deviation of less than 8 percent, showing that the membrane formed was repeatable and theoretically scaleable to commercial use. Conducting a Brunauer-Emmet-Teller (BET) analysis using a two-dimensional non-local density functional theory model (2D-NLDFT), the micropore distribution of Films 8a-8d was determined to be as shown in FIG. 5. Particularly, films 8a-8d were determined to have an average micropore size of approximately 5 angstroms.

To isolate the impact of oxidation, the non-oxidized PVDC microcapillary films previously discussed were also exposed to the same feed and conditions, the permeation results for which are shown in Table 3 below.

TABLE 3
Non-Oxidized Permeation Test Results

| | Pyrolysis | Anneal | Oxidation | CO₂ | H₂ | |
|---|---|---|---|---|---|---|
| | Temp | Temp | Temp | Perm | Perm | CO₂/H₂ |
| Example | (° C.) | (° C.) | (° C.) | GPU | GPU | Selectivity |
| Film 14 | 600 | 600 | NA | 52.6 | 201.3 | 0.3 |
| Film 15 | 600 | 900 | NA | 9.6 | 26.3 | 0.4 |
| Film 16 | 600 | 1200 | NA | 0.81 | 9.71 | 0.1 |
| Film 17 | 600 | 1500 | NA | 0.4 | 1.8 | 0.2 |

For films that did not have oxidation (Films 14-17), hydrogen permeance was actually observed to slightly exceed carbon dioxide permeance. As a trend, it was observed that permeance generally decreased as annealing temperature increased, which may be due to the general reordering and shrinkage of the pore matrix, as previously discussed.

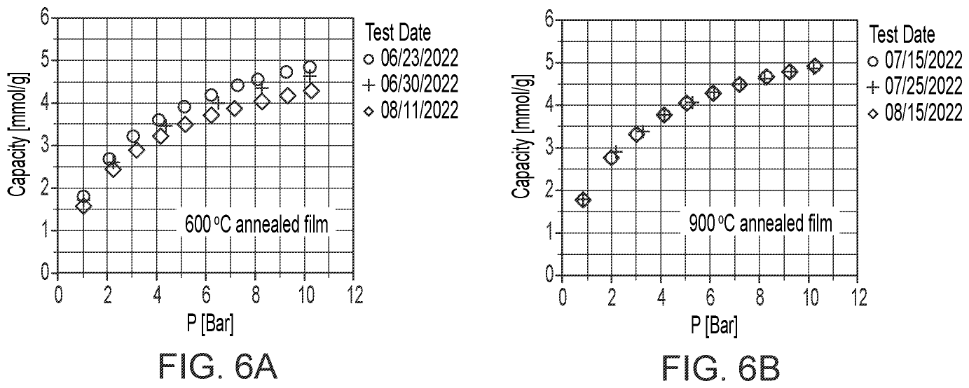

To determine the impact of why annealing in particular resulted in carbon structure stability, an analysis of absorption behavior over time and mechanical properties was conducted on films 14 and 15 (films without oxidation). Particularly, films 14 and 15 were subjected to carbon dioxide absorption at 50° C. and 1000 kPA on three separate occasions, as shown in FIGS. 6A-6B. Films 14 and 15 were left in lab atmosphere for at least two days between each adsorption test. A vacuum treatment at 100° C. was also used to pretreat films 14 and 15 prior to each adsorption test. As shown in FIG. 6A as compared to FIG. 6B, there was a significant reduction in carbon dioxide adsorption capabilities of the CMS membrane over time for film 14 as compared to film 15, which indicates that the higher temperature annealing resulted in a higher level of graphitization. This can also be evidenced in Table 4, which shows that films 14-17 exhibit increased graphitization (lower oxygen content), decreased electrical resistivity, and improved mechanical properties as the annealing temperature increased, up to an observable peak somewhere between 900° C. and 1500° C.

TABLE 4
Non-Oxidized Membranes, Graphitization Analysis

| | Anneal | Oxidation | Oxygen | | Max | Break | |
|---|---|---|---|---|---|---|---|
| | Temp | Temp | Content | Resistivity | Strain | Strength | Modulus |
| Example | (° C.) | (° C.) | (%) | (Ohm-cm) | (%) | (MPa) | (GPa) |
| Film 14 | 600 | NA | 7.9 | 1020 | 0.76 | 63.4 | 8.4 |
| Film 15 | 900 | NA | 1.8 | 0.023 | 0.85 | 142.9 | 17.0 |
| Film 16 | 1200 | NA | 2.6 | 0.011 | 1.04 | 173.7 | 16.8 |
| Film 17 | 1500 | NA | 1.1 | 0.010 | 0.77 | 118.9 | 15.5 |
| Film 2 | 900 | 300 | 11.6 | | | | |
| Film 3 | 900 | 325 | 13.9 | | | | |
| Film 4 | 900 | 350 | 16.0 | | | | |
| Film 6 | 1200 | 300 | 6.9 | | | | |
| Film 8 | 1200 | 350 | 10.9 | | | | |
| Film 9 | 1200 | 375 | 20.7 | | | | |
| Film 11 | 1500 | 350 | 4.8 | | | | |
| Film 12 | 1500 | 375 | 6.9 | | | | |
| Film 13 | 1500 | 400 | 7.2 | | | | |

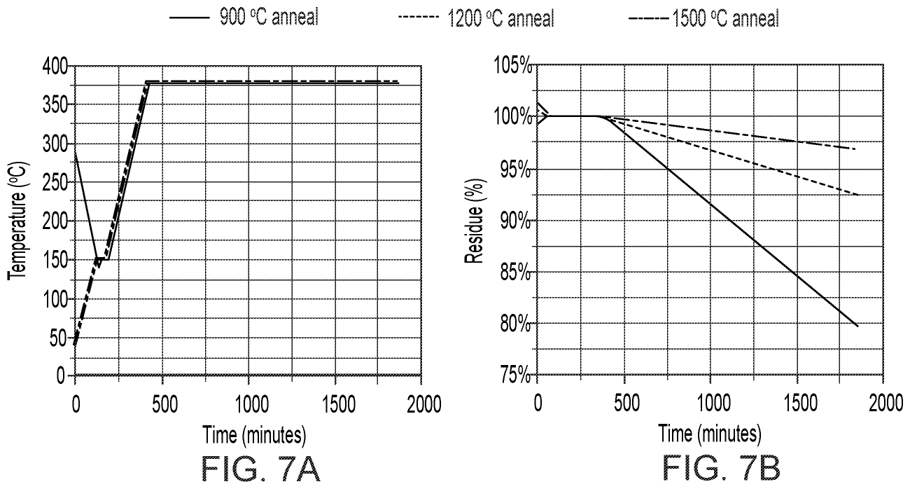

As illustrated in FIGS. 7A and 7B, oxidation resistance of the CMS membrane generally increases with increased annealing temperatures, consistent with the aforementioned conclusion that annealing reordering, shrinkage, and strengthening of the pore matrix during the annealing process. Oxidation of the membrane is generally recognized as an exothermic process, which can lead to destruction of the matrix in some situations, see the previous films/fibers that shattered during the oxidation process. Accordingly, a higher annealing temperature may be beneficial to slow the oxidation process and reduce the likelihood of shatter of the fibers/films during oxidation. Moreover, as previously stated with respect to Table 4, oxygen content of the CMS membrane generally decreases with increased annealing temperature. This trend also occurs in the resulting CMS membrane after oxidation, see Films 4, 8, and 11 above. Without being limited by theory, as oxygen content decreases, the resulting CMS membrane may also become more hydrophobic, due to removal of the polar oxygen species. A more hydrophobic CMS membrane may have the benefit of being less impacted by exposure to water moisture in the absorption process, an additional benefit.

According to a first aspect, a method of manufacturing a carbon molecular sieve (CMS) membrane may comprise forming a copolymer into one or more hollow fibers or one or more microcapillary films, the copolymer selected from one or more of a polyvinylidene chloride (PVDC) copolymer, a polyimide copolymer, polyetherimide copolymer, a polyacrylonitrile copolymer, and a poly(phenylene oxide) copolymer; pyrolyzing the one or more hollow fibers or the one or more microcapillary films at a second temperature of from 600° C. to 700° C. with inert gas or under vacuum; and annealing the one or more hollow fibers or the one or more microcapillary films at a third temperature of from 900° C. to 1500° C. with inert gas or under vacuum; oxidizing the one or more hollow fibers or the one or more microcapillary films at a fourth temperature of from 300° C. to 400° C. with air.

A second aspect may comprise the first aspect, and may further comprise cooling the one or more hollow fibers or the one or more microcapillary films to a temperature of less than or equal to 60° C. between pyrolyzing and annealing.

A third aspect may comprise any previous aspect, wherein the cooling step, the annealing step, or both occurs after observing greater than or equal to 70 percent weight loss of the one or more hollow fibers or the one or more microcapillary films in the pyrolyzing step.

A fourth aspect may comprise any previous aspect, wherein the copolymer comprises a polyvinylidene chloride (PVDC) copolymer; and the method further comprises, prior to pyrolyzing, pretreating the one or more hollow fibers or the one or more microcapillary films by heating at a first temperature of from 120° C. to 200° C. with air, inert gas, under vacuum, or combinations thereof.

A fifth aspect may comprise any previous aspect, wherein the copolymer comprises a polyimide copolymer.

A sixth aspect may comprise any previous aspect, wherein the oxidation step is stopped at less than 20 wt. % loss of the one or more hollow fibers or the one or more microcapillary films in the oxidation step.

A seventh aspect may comprise any previous aspect, wherein the CMS membrane comprises: a carbon dioxide permeance of at least 1000 GPU (Gas Permeation Unit); and a carbon dioxide/hydrogen selectivity of from 50 to 200 at 350 kPa gauge and ambient temperature.

An eighth aspect may comprise any previous aspect, wherein the CMS membrane comprises: a carbon dioxide permeance of at least 2000 GPU (Gas Permeation Unit); and a carbon dioxide/hydrogen selectivity of from 80 to 200 at 350 kPA and ambient temperature.

A ninth aspect may comprise any previous aspect, wherein the CMS membrane comprises a median pore size of approximately 4.5 angstroms to approximately 7 angstroms.

A tenth aspect may comprise any previous aspect, wherein the copolymer comprises at least one of the following comonomers: a vinyl monomer, a vinyl chloride monomer, an acrylate monomer, a methacrylate monomer, a styrenic monomer, acrylonitrile, methacrylonitrile, itaconic acid, and pyrolyzed chlorotrifluoroethylene.

An eleventh aspect may comprise any previous aspect, wherein the one or more hollow fibers are a first plurality of hollow fibers and a second plurality of hollow fibers; the first plurality of hollow fibers and the second plurality of hollow fibers are arranged in a woven lattice structure for the pretreating step, the pyrolyzing step, the cooling step, the annealing step, the oxidizing step, or combinations thereof.

A twelfth aspect may comprise a process for separating a gas mixture comprising hydrogen and carbon dioxide utilizing a CMS membrane manufactured according to any of the previous aspects, the method comprising: manufacturing the CMS membrane according to any previous aspect; and flowing the gas mixture through the CMS membrane to produce a permeate first stream having an increased concentration of carbon dioxide and a retentate second stream having an increased concentration of hydrogen.

A thirteenth aspect may comprise a carbon molecular sieve (CMS) membrane, the membrane comprising one or more hollow fibers or one or more microcapillary films, wherein: the one or more hollow fibers or the one or more microcapillary films comprise a copolymer selected from one or more of a polyvinylidene chloride (PVDC) copolymer, a polyimide copolymer, polyetherimide copolymer, a polyacrylonitrile copolymer, and a poly(phenylene oxide) copolymer; the CMS membrane comprises a carbon dioxide permeance of at least 1000 GPU (Gas Permeation Unit) and a carbon dioxide/hydrogen selectivity of from 50 to 200 at 350 kPa gauge and ambient temperature.

A fourteenth aspect may comprise the membrane of the previous aspect, wherein the one or more hollow fibers comprise a first plurality of hollow fibers and a second plurality of hollow fibers, and the first plurality of hollow fibers and the second plurality of hollow fibers are arranged in a woven lattice structure.

A fifteenth aspect may comprise a process for separating a gas mixture comprising hydrogen and carbon dioxide utilizing the CMS membrane of either claim 13 or 14, the process comprising flowing the gas mixture through the CMS membrane to produce: a permeate first stream having an increased concentration of carbon dioxide; and a retentate second stream having an increased concentration of hydrogen.

It is noted that recitations in the present disclosure of a component of the present disclosure being “operable” or “sufficient” in a particular way, to embody a particular property, or to function in a particular manner, are structural recitations, as opposed to recitations of intended use. More specifically, the references in the present disclosure to the manner in which a component is “operable” or “sufficient” denotes an existing physical condition of the component and, as such, is to be taken as a definite recitation of the structural characteristics of the component.

It is also noted that recitations herein of “at least one” component, element, etc., should not be used to create an inference that the alternative use of the articles “a” or “an” should be limited to a single component, element, etc. The singular forms “a,” “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” It is noted that the use of the terms “having” or “including”, or grammatical variations thereof, in this disclosure should also be interpreted in like manner as the more commonly used open-ended preamble term “comprising”.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

Having described the subject matter of the present embodiments herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present embodiments including, but not limited to, embodiments defined in the appended claims. More specifically, although some aspects of the present embodiments are identified herein as preferred or particularly advantageous, it is contemplated that the present embodiments is not necessarily limited to these aspects.

1. A method of manufacturing a carbon molecular sieve (CMS) membrane, the method comprising:
forming a copolymer into one or more hollow fibers comprising polyimide or one or more microcapillary films comprising polyvinylidene chloride (PVDC);
pyrolyzing the one or more hollow fibers or the one or more microcapillary films at a second temperature of from 600° C. to 700° C. with inert gas or under vacuum;
annealing the one or more hollow fibers or the one or more microcapillary films at a third temperature of from 900° C. to 1500° C. with inert gas or under vacuum; and
oxidizing the one or more hollow fibers or the one or more microcapillary films at a fourth temperature of from 300° C. to 400° C. with air, wherein:
the one or more microcapillary films are pretreated prior to pyrolyzing by heating at a first temperature of from 120° C. to 200° C. with air, the inert gas, under vacuum, or combinations thereof,
the annealing step occurs after observing greater than or equal to 70 percent weight loss of the one or more hollow fibers or the one or more microcapillary films in the pyrolyzing step, and
the oxidation step is stopped at less than 20 wt. % loss of the one or more hollow fibers or the one or more microcapillary films in the oxidation step.

2. The method of claim 1, further comprising cooling the one or more hollow fibers or the one or more microcapillary films to a temperature of less than or equal to 60° C. between pyrolyzing and annealing.

3-6. (canceled)

7. The method of claim 1, wherein oxidizing the one or more hollow fibers or the one or more microcapillary films at the fourth temperature with air results in a CMS membrane with:
a carbon dioxide permeance of at least 1000 GPU (Gas Permeation Unit) at 350 kPa gauge and ambient temperature (20° C.) for an equimolar carbon dioxide and hydrogen feed; and
a carbon dioxide/hydrogen selectivity of from 50 to 200 at 350 kPa gauge and ambient temperature for an equimolar carbon dioxide and hydrogen feed.

8. The method of claim 1, wherein oxidizing the one or more hollow fibers or the one or more microcapillary films at the fourth temperature with air results in a CMS membrane with:
a carbon dioxide permeance of at least 2000 GPU (Gas Permeation Unit) at 350 kPa gauge and ambient temperature (20° C.) for an equimolar carbon dioxide and hydrogen feed; and
a carbon dioxide/hydrogen selectivity of from 80 to 200 at 350 kPA and ambient temperature for an equimolar carbon dioxide and hydrogen feed.

9. The method of claim 1, wherein oxidizing the one or more hollow fibers or the one or more microcapillary films at the fourth temperature with air results in a CMS membrane with a median pore size of approximately 4.5 angstroms to approximately 7 angstroms, the median pore size determined by gas adsorption.

10. The method of claim 1, wherein the copolymer comprises at least one of the following comonomers: a vinyl monomer, a vinyl chloride monomer, an acrylate monomer, a methacrylate monomer, a styrenic monomer, acrylonitrile, methacrylonitrile, itaconic acid, and pyrolyzed chlorotrifluoroethylene.

11. The method of claim 1, wherein:
the one or more hollow fibers are a first plurality of hollow fibers and a second plurality of hollow fibers;
the first plurality of hollow fibers and the second plurality of hollow fibers are arranged in a woven lattice structure for the pretreating step, the pyrolyzing step, the cooling step, the annealing step, the oxidizing step, or combinations thereof.

12. A process for separating a gas mixture comprising hydrogen and carbon dioxide utilizing a CMS membrane manufactured according to claim 1, the method comprising:
flowing the gas mixture through the CMS membrane to produce a permeate first stream having an increased concentration of carbon dioxide and a retentate second stream having an increased concentration of hydrogen.

13. A carbon molecular sieve (CMS) membrane, the membrane comprising one or more hollow fibers or one or more microcapillary films, wherein:
the one or more hollow fibers or the one or more microcapillary films comprise a copolymer selected from one or more of a polyvinylidene chloride (PVDC) copolymer, a polyimide copolymer, polyetherimide copolymer, a polyacrylonitrile copolymer, and a poly(phenylene oxide) copolymer;
the CMS membrane comprises a carbon dioxide permeance of at least 1000 GPU (Gas Permeation Unit) and a carbon dioxide/hydrogen selectivity of from 50 to 200, the permeance and selectivity measured at 350 kPa gauge and ambient temperature (20° C.), and for an equimolar carbon dioxide and hydrogen feed.

14. The membrane of claim 13, wherein:
the one or more hollow fibers comprise a first plurality of hollow fibers and a second plurality of hollow fibers; and
the first plurality of hollow fibers and the second plurality of hollow fibers are arranged in a woven lattice structure.

15. A process for separating a gas mixture comprising hydrogen and carbon dioxide utilizing the CMS membrane of claim 13, the process comprising flowing the gas mixture through the CMS membrane to produce:
a permeate first stream having an increased concentration of carbon dioxide; and
a retentate second stream having an increased concentration of hydrogen.

16. The method of claim 1, wherein:
the copolymer is formed into the one or more hollow fibers comprising polyimide;
the one or more hollow fibers are annealed for a period of from 2 hours to 10 hours; and
the one or more hollow fibers are oxidized for a period of from 2 hours to 10 hours.

17. The method of claim 1, wherein:
the copolymer is formed into the one or more microcapillary films comprising polyvinylidene chloride;
the one or more microcapillary films are annealed for a period of from 2 hours to 20 hours; and
the one or more microcapillary films are oxidized for a period of from 2 hours to 10 hours.
